(19) United States
(12) Patent Application Publication
(10) Pub. No.: US 2006/0207391 A1
(43) Pub. Date: Sep. 21, 2006

(54) Hammer having enhanced strength

(76) Inventor: John Chen, Taichung County (TW)

Correspondence Address: CHARLES E. BAXLEY, ESQ., 90 JOHN STREET, THIRD FLOOR, NEW YORK, NY, 10038, US

(21) Appl. No.: 11/083,000

(22) Filed: Mar. 17, 2005

(51) Int. Cl. B25D 1/00; B25D 1/12

(52) U.S. Cl. 81/22; 81/20

(57) ABSTRACT

A hammer includes a handle, an elongated support bar having a first end mounted on a first end of the handle, a grip portion mounted on the support bar and having an end portion rested on the first end of the handle, a fitting member mounted on the first end of the support bar and inserted into and locked in the end portion of the grip portion, and a limit unit adjustably mounted on a second end of the support bar and rested on the fitting member to limit movement of the fitting member. Thus, the grip portion is positioned on the handle by the fitting member and the limit unit on the support bar, so that the grip portion is mounted on the handle rigidly and stably.

### BACKGROUND OF THE INVENTION

1. Field of the Invention

The present invention relates to a hammer, and more particularly to a hammer having an enhanced strength.

2. Description of the Related Art

A conventional hammer comprises a handle having a first end provided with a reduced extension and a second end provided with a striking face, and a soft grip portion mounted on the extension of the handle. However, the grip portion is bonded on the extension of the handle by adhesive, so that the grip portion is easily loosened from the extension of the handle during a long-term utilization.

### SUMMARY OF THE INVENTION

The present invention is to mitigate and/or obviate the disadvantage of the conventional hammer.

The primary objective of the present invention is to provide a hammer having an enhanced strength.

Another objective of the present invention is to provide a hammer, wherein the grip portion is positioned on the handle by the fitting member and the limit unit on the support bar, so that the grip portion is mounted on the handle rigidly and stably.

A further objective of the present invention is to provide a hammer, wherein the fitting member provides a shock-absorbing effect to the grip portion, thereby facilitating a user holding the grip portion to operate the hammer.

A further objective of the present invention is to provide a hammer, wherein the fitting member is interlocked with the limit unit to enhance the combination strength of the grip portion and the handle.

A further objective of the present invention is to provide a hammer, wherein the protruding abutment of the fitting member has a periphery matching that of the handle and the grip portion to form an integrated peripheral surface, thereby enhancing the aesthetic quality of the hammer.

In accordance with the present invention, there is provided a hammer, comprising:

a handle;

an elongated support bar having a first end mounted on a first end of the handle;

a grip portion mounted on the support bar and having an end portion rested on the first end of the handle;

a fitting member mounted on the first end of the support bar and inserted into and locked in the end portion of the grip portion; and

a limit unit adjustably mounted on a second end of the support bar and rested on the fitting member to limit movement of the fitting member.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hammer in accordance with the preferred embodiment of the present invention;

FIG. 2 is a partially enlarged perspective view of the hammer as shown in FIG. 1;

FIG. 3 is an exploded perspective view of the hammer as shown in FIG. 2;

FIG. 4 is a plan view of the hammer as shown in FIG. 2; and

FIG. 5 is a plan cross-sectional view of the hammer as shown in FIG. 2.

### DETAILED DESCRIPTION OF THE INVENTION

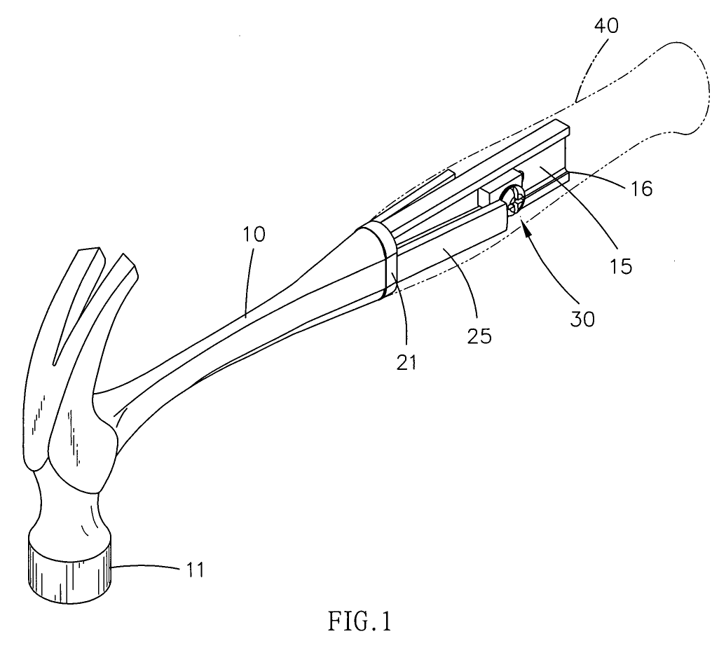

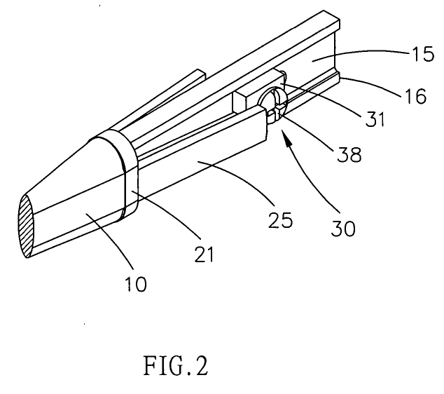

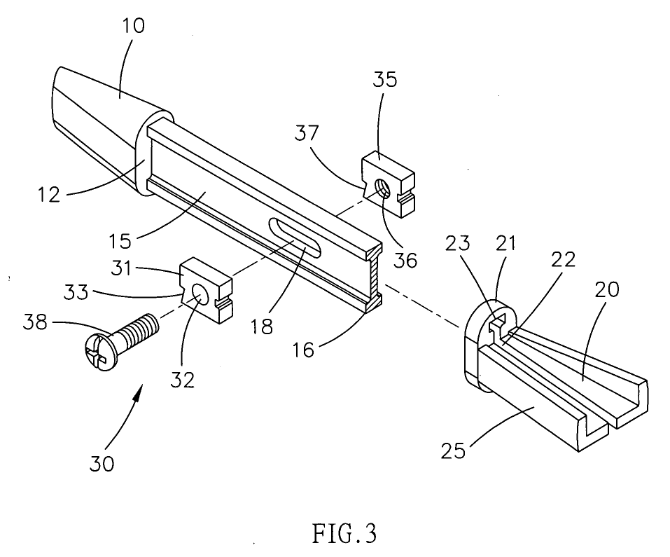

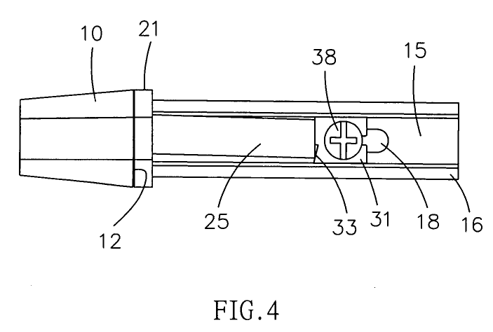

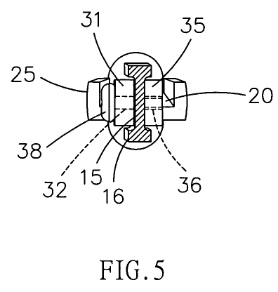

Referring to FIGS. 1-5, a hammer in accordance with the preferred embodiment of the present invention comprises a handle 10, an elongated support bar 15 having a first end mounted on a first end of the handle 10, a grip portion 40 mounted on the support bar 15 and having an end portion rested on the first end of the handle 10, a fitting member 20 mounted on the first end of the support bar 15 and inserted into and locked in the end portion of the grip portion 40, and a limit unit 30 adjustably mounted on a second end of the support bar 15 and rested on the fitting member 20 to limit movement of the fitting member 20.

The handle 10 has a second end provided with a striking face 11.

The grip portion 40 is made of a soft material.

The support bar 15 has a substantially I-shaped cross-sectional profile and has two opposite edges each formed with a protruding rib 16 extended outward in a direction perpendicular to a longitudinal direction of the support bar 15 to enhance the strength of the support bar 15. The second end of the support bar 15 is formed with an oblong adjusting slot 18.

The fitting member 20 is made of a plastic material and has a periphery connected to a periphery of the first end of the handle 10 to form an integrated peripheral surface. The fitting member 20 has a first end formed with a protruding abutment 21 rested on an end face 12 of the first end of the handle 10. The protruding abutment 21 of the fitting member 20 has an inside formed with a passage 22 mounted on the support bar 15. The passage 22 of the protruding abutment 21 has a substantially I-shaped cross-sectional profile to allow passage of the support bar 15 and has two opposite edges each formed with a groove 23 to allow passage of the protruding rib 16 of the support bar 15. The protruding abutment 21 of the fitting member 20 has a periphery matching that of the handle 10 and the grip portion 40 to form an integrated peripheral surface. The protruding abutment 21 of the fitting member 20 has two sides each formed with an upright protruding plate 25 having a periphery matching the periphery of the first end of the handle 10 to form an integrated peripheral surface.

The limit unit 30 includes a first catch block 31 adjustably mounted on a first side of the support bar 15 and rested on a second end of the fitting member 20, a second catch block 35 adjustably mounted on a second side of the support bar 15 and rested on the second end of the fitting member 20, and a locking bolt 38 extended through the first catch block 31, the support bar 15 and the second catch block 35. The first catch block 31 is formed with a through hole 32, the second catch block 35 is formed with a screw bore 36, and the locking bolt 38 is extended through the through hole 32 of the first catch block 31 and the adjusting slot 18 of the support bar 15 and screwed into the screw bore 36 of the second catch block 35 to lock the first catch block 31 and the second catch block 35 on the support bar 15. Thus, the adjusting slot 18 of the support bar 15 adjusts the position of the first catch block 31 and the second catch block 35. The first catch block 31 has a side formed with a first wedge 33 rested on the second end of the fitting member 20, and the second catch block 35 has a side formed with a second wedge 37 rested on the second end of the fitting member 20. Thus, the fitting member 20 is positioned on the support bar 15 rigidly and stably.

Accordingly, the grip portion 40 is positioned on the handle 10 by the fitting member 20 and the limit unit 30 on the support bar 15, so that the grip portion 40 is mounted on the handle 10 rigidly and stably. In addition, the fitting member 20 provides a shock-absorbing effect to the grip portion 40, thereby facilitating a user holding the grip portion 40 to operate the hammer. Further, the fitting member 20 is interlocked with the limit unit 30 to enhance the combination strength of the grip portion 40 and the handle 10. Further, the protruding abutment 21 of the fitting member 20 has a periphery matching that of the handle 10 and the grip portion 40 to form an integrated peripheral surface, thereby enhancing the aesthetic quality of the hammer.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A hammer, comprising:
a handle;
an elongated support bar having a first end mounted on a first end of the handle;
a grip portion mounted on the support bar and having an end portion rested on the first end of the handle;
a fitting member mounted on the first end of the support bar and inserted into and locked in the end portion of the grip portion; and
a limit unit adjustably mounted on a second end of the support bar and rested on the fitting member to limit movement of the fitting member.

2. The hammer in accordance with claim 1, wherein the support bar has a substantially I-shaped cross-sectional profile and has two opposite edges each formed with a protruding rib extended outward in a direction perpendicular to a longitudinal direction of the support bar.

3. The hammer in accordance with claim 1, wherein the fitting member is made of a plastic material.

4. The hammer in accordance with claim 1, wherein the fitting member has a periphery connected to a periphery of the first end of the handle to form an integrated peripheral surface.

5. The hammer in accordance with claim 1, wherein the fitting member has a first end formed with a protruding abutment rested on an end face of the first end of the handle.

6. The hammer in accordance with claim 5, wherein the protruding abutment of the fitting member has an inside formed with a passage mounted on the support bar.

7. The hammer in accordance with claim 6, wherein the support bar has a substantially I-shaped cross-sectional profile and has two opposite edges each formed with a protruding rib extended outward in a direction perpendicular to a longitudinal direction of the support bar, and the passage of the protruding abutment has a substantially I-shaped cross-sectional profile to allow passage of the support bar and has two opposite edges each formed with a groove to allow passage of the protruding rib of the support bar.

8. The hammer in accordance with claim 5, wherein the protruding abutment of the fitting member has a periphery matching that of the handle and the grip portion to form an integrated peripheral surface.

9. The hammer in accordance with claim 1, wherein the protruding abutment of the fitting member has two sides each formed with an upright protruding plate having a periphery matching the periphery of the first end of the handle to form an integrated peripheral surface.

10. The hammer in accordance with claim 5, wherein the limit unit includes a first catch block adjustably mounted on a first side of the support bar and rested on a second end of the fitting member, a second catch block adjustably mounted on a second side of the support bar and rested on the second end of the fitting member, and a locking bolt extended through the first catch block, the support bar and the second catch block.

11. The hammer in accordance with claim 10, wherein the second end of the support bar is formed with an oblong adjusting slot, the first catch block is formed with a through hole, the second catch block is formed with a screw bore, and the locking bolt is extended through the through hole of the first catch block and the adjusting slot of the support bar and screwed into the screw bore of the second catch block to lock the first catch block and the second catch block on the support bar.

12. The hammer in accordance with claim 10, wherein the adjusting slot of the support bar adjusts the position of the first catch block and the second catch block.

13. The hammer in accordance with claim 10, wherein the first catch block has a side formed with a first wedge rested on the second end of the fitting member, and the second catch block has a side formed with a second wedge rested on the second end of the fitting member.

14. The hammer in accordance with claim 1, wherein the handle has a second end provided with a striking face.

15. The hammer in accordance with claim 1, wherein the grip portion is positioned on the handle by the fitting member and the limit unit on the support bar.

16. The hammer in accordance with claim 1, wherein the fitting member provides a shock-absorbing effect to the grip portion.

17. The hammer in accordance with claim 1, wherein the fitting member is interlocked with the limit unit to enhance the combination strength of the grip portion and the handle.
